(19) United States
(12) Patent Application Publication
(10) Pub. No.: US 2015/0023413 A1
(43) Pub. Date: Jan. 22, 2015

(54) METHOD AND DEVICE FOR CONTROLLING VIDEO BIT RATE

(71) Applicant: Electronics and Telecommunications Research Institute, Daejeon (KR)

(72) Inventors: Soon heung Jung, Daejeon (KR); Dong San Jun, Daejeon (KR); Youn Hee Kim, Daejeon (KR); Jin Soo Choi, Daejeon (KR); Jin Woong Kim, Daejeon (KR)

(73) Assignee: Electronics and Telecommunications Research Institute, Daejeon (KR)

(21) Appl. No.: 14/383,257

(22) PCT Filed: Dec. 27, 2012
(86) PCT No.: PCT/KR2012/011547

§ 371 Date: Sep. 5, 2014

(30) Foreign Application Priority Data
Mar. 5, 2012 (KR) 10-2012-0022546

(51) Int. Cl. H04N 19/172; H04N 19/119; H04N 19/124

(52) U.S. Cl. CPC H04N 19/00266; H04N 19/0009; H04N 19/00072
USPC 375/240.03; 375/240.02

(57) ABSTRACT

A method of controlling a video bit rate includes splitting the current frame into a plurality of first sub frames, deriving a sub frame goal bit rate for each of the plurality of first sub frames, and deriving a QP value for each of the plurality of first sub frames on the basis of the derived sub frame goal bit rate. According to the method, video coding efficiency may be enhanced.

### TECHNICAL FIELD

The prediction invention relates to image processing, and more specifically to a video bit rate control method and apparatus.

### BACKGROUND ART

A video may have various bit rates according to the service environment and purposes. In general, a video is encoded to have a similar bit rate on a per-second basis and then serviced. Bit rate control methods are increasing growing with the development of video encoding devices. Generally, an encoding device assigns a bit rate to each frame to provide a desired bit rate and controls the bit rate of an output by adjusting the QP value.

Meanwhile, as images to be subjected to video encoding happen to gradually have a high resolution, there is an ongoing research on parallel processing structures for real-time processing of video encoding. As a method for parallel processing, one frame may be split into plural regions which are then encoded at the same time.

### DISCLOSURE

### Technical Problem

An object of the present invention is to provide a video encoding method and apparatus that may enhance video encoding efficiency.

An object of the present invention is to provide a video decoding method and apparatus that may enhance video encoding efficiency.

An object of the present invention is to provide a video bit rate control method and apparatus that may enhance video encoding efficiency.

### Technical Solution

According to an aspect of the present invention, a video encoding method includes the steps of splitting a current frame into a plurality of first sub frames, deriving a sub frame target bit amount for each of the plurality of first sub frames, deriving a plurality of sub frame bit streams each of which corresponds to a single sub frame by performing encoding on the plurality of first sub frames based on the derived sub frame target bit amount, and integrating the plurality of sub frame bit streams and outputting a single bit stream.

The step of deriving the plurality of sub frame bit streams may include performing encoding on each of the plurality of first sub frames using a plurality sub-encoding units each of which corresponds to a single sub frame.

In a case where the current frame is a first frame in an input video, the step of deriving the sub frame target bit amount may include deriving the sub frame target bit amount by dividing a frame target bit amount assigned to the current frame by the number of the plurality of first sub frames.

In a case where the current frame is not a first frame in an input video, the step of deriving the sub frame target bit amount may include deriving the sub frame target bit amount based on a bit amount actually generated in the course of encoding of each of a plurality of second sub frames constituting a previous frame and an average QP (Quantization Parameter) value for each of the plurality of second sub frames.

The step of deriving the sub frame target bit amount may comprise the steps of calculating a first weight based on the average QP value, calculating a second weight based on the actually generated bit amount, and deriving the sub frame target bit amount by applying the first weight and the second weight to a frame target bit amount assigned to the current frame.

According to another embodiment of the present invention, a video encoding apparatus includes a frame splitting unit that splits a current frame into a plurality of first sub frames, a bit rate control unit that derives a sub frame target bit amount for each of the plurality of first sub frames, a sub frame encoding unit that derives a plurality of sub frame bit streams each of which corresponds to a single sub frame by performing encoding on the plurality of first sub frames based on the derived sub frame target bit amount, and a bit stream integrator that integrates the plurality of sub frame bit streams into a single bit stream.

The sub frame encoding unit may include a plurality of sub-encoding units each of which corresponds to a single sub frame, wherein each of the plurality of sub-encoding units performs encoding on a sub frame corresponding to the each of the plurality of sub-encoding units.

In a case where the current frame is a first frame in an input video, the bit rate control unit may derive the sub frame target bit amount by dividing a frame target bit amount assigned to the current frame by the number of the plurality of first sub frames.

In a case where the current frame is not a first frame in an input video, the bit rate control unit may derive the sub frame target bit amount based on a bit amount actually generated in the course of encoding of each of a plurality of second sub frames constituting a previous frame and an average QP (Quantization Parameter) value for each of the plurality of second sub frames.

The bit rate control unit may calculate a first weight based on the average QP value, calculate a second weight based on the actually generated bit amount, and derive the sub frame target bit amount by applying the first weight and the second weight to a frame target bit amount assigned to the current frame.

According to still another aspect of the present invention, a video bit rate control method includes the steps of splitting a current frame into a plurality of first sub frames, deriving a sub frame target bit amount for each of the plurality of first sub frames, and deriving a QP value for each of the plurality of first sub frames based on the derived sub frame target bit amount.

In a case where the current frame is a first frame in an input video, the step of deriving the sub frame target bit amount may include deriving the sub frame target bit amount by dividing a frame target bit amount assigned to the current frame by the number of the plurality of first sub frames.

In a case where the current frame is not a first frame in an input video, the step of deriving the sub frame target bit amount may include deriving the sub frame target bit amount based on a bit amount actually generated in the course of encoding of each of a plurality of second sub frames constituting a previous frame and an average QP (Quantization Parameter) value for each of the plurality of second sub frames.

The step of deriving the sub frame target bit amount may include the steps of calculating a first weight based on the average QP value, calculating a second weight based on the actually generated bit amount, and deriving the sub frame target bit amount by applying the first weight and the second weight to a frame target bit amount assigned to the current frame.

### Advantageous Effects

A video encoding method and apparatus according to the present invention may enhance video encoding efficiency.

A video decoding method and apparatus according to the present invention may enhance video encoding efficiency.

A video bit rate control method and apparatus according to the present invention may enhance video encoding efficiency.

### DESCRIPTION OF DRAWINGS

FIG. 1 is a block diagram illustrating a configuration of an image encoding apparatus according to an embodiment of the present invention.

FIG. 2 is a block diagram illustrating a configuration of an image decoding apparatus according to an embodiment of the present invention.

FIG. 3 is a conceptual view schematically illustrating a bit rate control method according to an embodiment of the present invention.

FIG. 4 is a flowchart schematically illustrating a bit rate control method of a video encoding unit according to an embodiment of the present invention.

FIG. 5 is a block diagram schematically illustrating a video encoding unit according to an embodiment of the present invention.

FIG. 6 is a conceptual view schematically illustrating a frame that is split into sub frames according to an embodiment of the present invention.

FIG. 7 is a flowchart schematically illustrating a bit rate control method according to an embodiment of the present invention.

FIG. 8 is a conceptual view schematically illustrating a bit rate control method according to another embodiment of the present invention.

### BEST MODE

Hereinafter, embodiments of the present invention will be described in detail with reference to the drawings. In describing the embodiments of the invention, when determined to make the gist of the invention unclear, the specific description of the relevant known configuration or functions will be omitted.

When an element is “connected to” or “coupled to” another element, the element may be directly connected or coupled to the other element, but other elements may also be present therebetween. Further, “including” a specific configuration does not exclude other configurations, and rather an additional configuration may be included in the embodiments or the scope of the invention.

The terms, such as “first” and “second”, may be used to describe various components, but the components should not be limited to the terms. The terms are used only to distinguish one element from another. For example, a first component may be named a second component without departing from the scope of the invention, and similarly, the second component may be also named the first component.

The components in the embodiments of the invention are independently illustrated to represent different features from each other, and it does not mean that each component is not composed of separate hardware or one software component unit. That is, the components are separated from each other for convenience of description, and at least two components may be combined into a single component or one component may be split into plural components which then may perform respective functions. The combined or split components are also included in the scope of the invention without departing from the gist of the invention.

Further, some components are not inevitable components that perform essential functions of the invention but may be optional components for merely enhancing performance The present invention may be implemented as including only the components necessary for implementing the gist of the invention except for components used for merely enhancing performance, and any configuration including only the necessary components except for the optional components used for merely enhancing performance is also included in the scope of the invention.

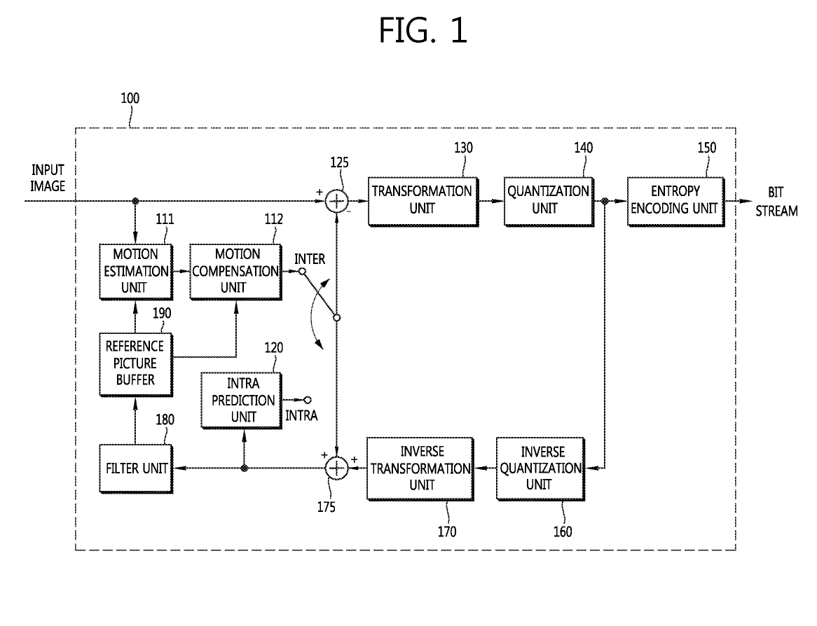

FIG. 1 is a block diagram illustrating a configuration of an image encoding apparatus according to an embodiment of the present invention.

Referring to FIG. 1, the image encoding apparatus 100 includes a motion estimation unit 111, a motion compensation unit 112, an intra prediction unit 120, a switch 115, a subtracter 125, a transformation unit 130, a quantization unit 140, an entropy encoding unit 150, an inverse quantization unit 160, an inverse transformation unit 170, an adder 175, a filter unit 180, and a reference picture buffer 190.

The image encoding apparatus 100 may perform intra mode or inter mode encoding on an input image and may output a bit stream. In the case of an intra mode, the switch 115 switches to “intra”, and in the case of an inter mode, the switch 115 may switch to “inter”. The image encoding apparatus 100 may generate a prediction block for an input block of the input image and then may encode a residual between the input block and the prediction block.

In the case of the intra mode, the intra prediction unit 120 may generate a prediction block by performing spatial prediction using a pixel value of an already encoded block adjacent to a current block.

In the case of the inter mode, the motion estimation unit 111 may obtain a motion vector by finding a region that matches best the input block in a reference image stored in the 190 in the course of motion estimation. The motion compensation unit 112 may generate a prediction block by performing motion compensation using the motion vector.

The subtracter 125 may generate a residual block by the residue between the input block and the generated prediction block. The transformation unit 130 may output a transform coefficient by performing transform on the residual block. The quantization unit 140 may quantize the input transform coefficient according to a quantization parameter and may output the quantized coefficient.

The entropy encoding unit 150 may output a bit stream by performing entropy encoding based on the encoding parameter value calculated in the course of encoding or values calculated by the quantization unit 140.

Upon application of entropy encoding, symbols are represented so that a smaller number of bits are assigned to a symbol having a high chance of being generated and a larger number of bits are assigned to a symbol having a low chance of being generated, and thus, the size of bit stream for symbols to be encoded may be decreased. Accordingly, compression performance of image encoding may be increased by entropy encoding. The entropy encoding unit 150 may use an encoding scheme, such as exponential golomb, CAVLC(Context-Adaptive Variable Length Coding), or CABAC(Context-Adaptive Binary Arithmetic Coding), so as to perform entropy encoding.

Since the image encoding apparatus illustrated in FIG. 1 performs inter prediction encoding, i.e., inter-frame prediction encoding, a currently encoded image needs to be decoded and stored to be used as a reference image. Accordingly, the quantized coefficient is inverse-quantized in the inverse quantization unit 160 and inverse-transformed in the inverse transformation unit 170. The inverse-quantized, inverse-transformed coefficient is added to the prediction block by the adder 175 and a reconstructed block is generated.

The reconstructed block goes through the filter unit 180, and the filter unit 180 may apply at least one or more of a de-blocking filter, an SAO (Sample Adaptive Offset), and an ALF (Adaptive Loop Filter) to the reconstructed block or reconstructed picture. The filter unit 180 may also be called an adaptive in-loop filter. The de-blocking filter may remove a block distortion that is created at a boundary between blocks. The SAO may add a proper offset value to the pixel value to compensate for a coding error. The ALF may perform filtering based on a value obtained by comparing the reconstructed image with the original image. The reconstructed block that has passed through the filter unit 180 may be stored in the reference picture buffer 190.

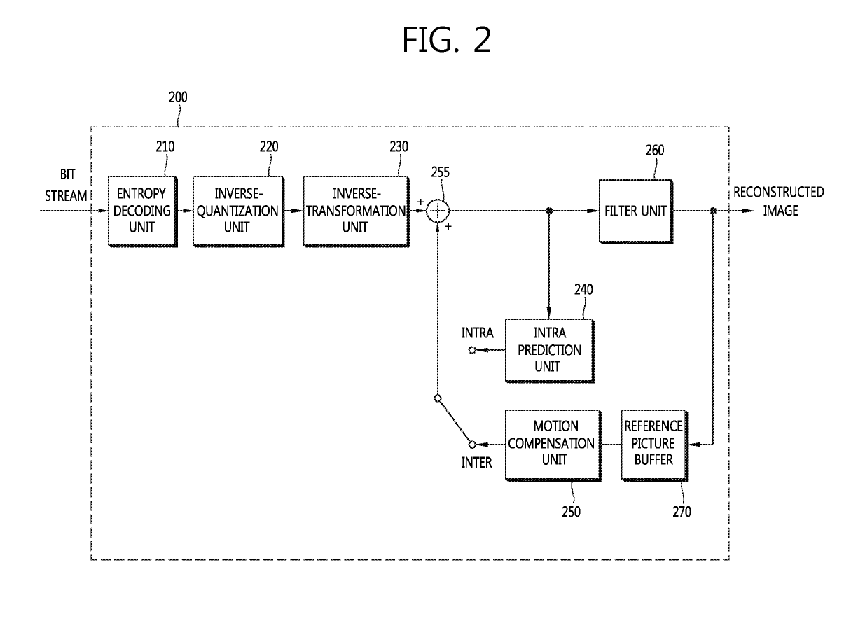

FIG. 2 is a block diagram illustrating a configuration of an image decoding apparatus according to an embodiment of the present invention.

Referring to FIG. 2, the image decoding apparatus 200 includes an entropy decoding unit 210, an inverse-quantization unit 220, an inverse-transformation unit 230, an intra prediction unit 240, a motion compensation unit 250, an adder 255, a filter unit 260, and a reference picture buffer 270.

The image decoding apparatus 200 may receive the bit stream from the encoding unit, perform encoding in an intra mode or an inter mode, and output a reconstructed image, i.e., reconstructed image. In the case of the intra mode, the switch may switch to “intra”, and in the case of the inter mode, the switch may switch to “inter”. The image decoding apparatus 200 may obtain a residual block reconstructed from the received bit stream, generate a prediction block, and add the reconstructed residual block to the prediction block to thereby generate a reconstructed block, i.e., reconstructed block.

The entropy decoding unit 210 may entropy-decode the input bit stream according to a probability distribution to thereby generate symbols including symbols of a quantized coefficient type. The entropy decoding method is similar to the above-described entropy encoding method.

Upon application of the entropy decoding method, symbols are represented so that a smaller number of bits are assigned to a symbol having a high chance of being generated, and a larger number of bits are assigned to a symbol having a low chance of being generated. Accordingly, compression performance of image decoding may be increased by the entropy decoding method.

The quantized coefficient is inverse-quantized in the inverse-quantization unit 220 and inverse-transformed in the inverse-transformation unit 230, and as a result of inverse quantization/inverse transformation of the quantized coefficient, a reconstructed residual block may be generated.

In the case of the intra mode, the intra prediction unit 240 may generate a prediction block by performing spatial prediction using a pixel value of an already encoded block adjacent to a current block. In the case of the inter mode, the motion compensation unit 250 may generate a prediction block by performing motion compensation using a reference image stored in the reference picture buffer 270 and the motion vector.

The reconstructed residual block and the prediction block are added to each other in the adder 255, and the added blocks may undergo the filter unit 260. The filter unit 260 may apply at least one or more of a de-blocking filter, an SAO, and an ALF to the reconstructed block or reconstructed picture. The filter unit 260 may output the reconstructed image, i.e., reconstructed image. The reconstructed image may be stored in the 270 and may be used for inter prediction.

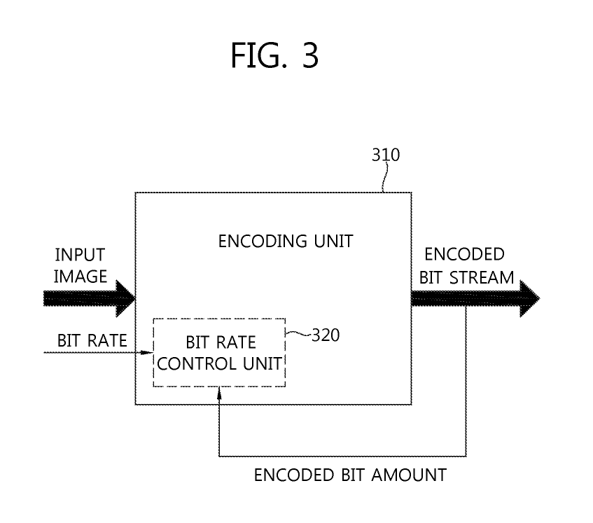

FIG. 3 is a conceptual view schematically illustrating a bit rate control method according to an embodiment of the present invention. FIG. 3 illustrates a video encoding unit 310 and a bit rate control unit 320 included in the video encoding unit 310.

The video encoding unit 310 may split one frame into plural regions for video encoding parallel processing and may perform encoding on the split plural regions at the same time. At this time, the plural split regions may have the same size.

In the case that encoding is simultaneously performed on the plural regions, if the same bit rate is assigned to each of the plural regions, a quality gap for each region may occur according to characteristics of an image, and thus, a user may feel uncomfortable. Accordingly, in the case that simultaneous encoding is conducted on the plural regions, the encoding unit needs to properly control the bit rate for each of the plural regions.

Referring to FIG. 3, the video encoding unit 310 may receive an input image and a bit rate and may output a bit stream. At this time, the bit rate control unit 320 may receive the bit rate and information on the amount of encoded bits, which are actually generated in the course of encoding, and may perform bit rate control. An output having a given bit rate may be obtained by the bit rate control process.

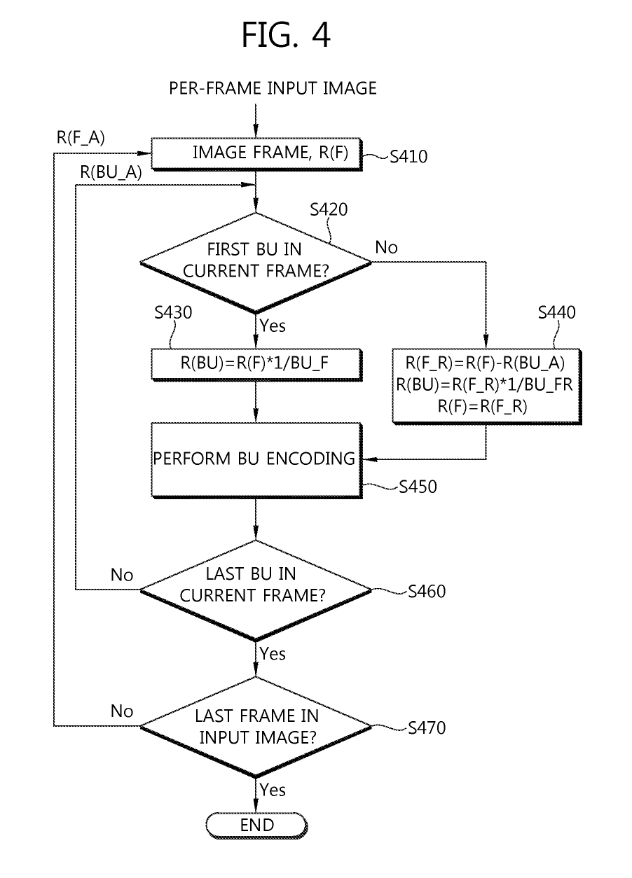

FIG. 4 is a flowchart schematically illustrating a bit rate control method of a video encoding unit according to an embodiment of the present invention.

An input image may be input to an encoding unit on a per-frame basis. At this time, the encoding unit may assign a bit rate to the input image on a per-frame basis and may perform encoding. The encoding unit may set a basic unit (hereinafter, referred to as “BU”) for bit rate allocation and/or bit rate control to a region having a predetermined size in one frame. That is, the encoding unit may split one frame into plural BUs and one frame may constitute plural BUs. The BU represents each region of the split frame, and thus, may be also represented as SF.

Here, the BU may be constituted of one or more blocks. Here, the block may refer to a unit for image encoding and decoding. Upon image encoding and decoding, the unit for encoding or decoding means a unit split when an image is split and encoded or decoded, and thus, it may be referred to as a macroblock, a coding unit (CU), a prediction unit (PU), or a transform unit (TU).

Referring to FIG. 4, when an input image is input to the encoding unit on a per-frame basis, the encoding unit may determine a frame to be encoded and a frame target bit amount (R(F)) that is assigned to the frame to be encoded (S410). Here, the frame to be encoded may be constituted of plural BUs, and the encoding unit may control a bit rate with respect to each BU.

If the frame to be encoded and the frame target bit amount R(F) are determined, the encoding unit may determine whether a current BU is a first BU in a current frame (S420).

In the case that the current BU is the first BU in the current frame, the encoding unit may determine a BU target bit amount (R(BU)) allocated to the current BU by dividing the frame target bit amount (R(F)) by the number (BU_F) of BUs in the current frame (S430). For example, assume that the bit amount allocated to one frame is 170 bits, and one frame consists of 16 BUs. At this time, the bit amount allocated to the first BU may be 170 bits* 1/16=10.625 bits.

In the case that the current BU is not the first BU in the current frame, the encoding unit may perform bit rate control on the current BU according to an encoding result of previous BU(s) (S440). That is, the encoding unit may adjust the bit rate of remaining regions according to the encoding result of the encoded BU in the frame. This may be represented in the following equation 1 as shown in FIG. 4:

R(F_{—}R)=R(F)−R(BU_{—}A) [Equation 1]

R(BU)=R(F_{—}R)*1/BU_{—}FR

R(F)=R(F_{—}R)

Here, R(BU_A) may refer to the bit amount that has been actually created in the course of encoding on the previous BU. BU_FR may refer to the number of BUs that are not encoded in the current frame.

For example, assume that the bit amount allocated to one frame is 170 bits, and one frame consists of 16 BUs. Further, assume that the bit amount actually created in the course of encoding of the first BU is 20 bits. At this time, the bit amount allocated to the second BU may be (170 bits−20 bits)* 1/15=10 bits. And, according to a result of encoding on the second BU, the bit amount allocated to the third BU may be determined, and the fourth and the subsequent BUs may also be sequentially subjected to the same bit rate control.

In the case that the BU target bit amount (R(BU)) allocated to the current BU is determined, the encoding unit may perform encoding on the current BU based on the determined BU target bit amount (S450).

If encoding on the current BU is performed, the encoding unit may determine whether the current BU is the last BU in the current frame (S460). Unless the current BU is the last BU in the current frame, information on the actual bit amount (R(BU_A)) created in the course of encoding may be used for bit rate control on the next BU. In the case that the current BU is the last BU in the current frame, encoding on all the BUs in the frame may be complete.

If all the BUs in the current frame are completely encoded, the encoding unit may determine whether the current frame is the last frame in the input image (S470). In the case that the current frame is the last frame in the input image, the encoding process on the input image may be terminated. Unless the current frame is the last frame in the input image, information on the actual bit amount (R(F_A)) created in the course of encoding on the whole current frame may be used to calculate the bit amount allocated to a next frame. At this time, the encoding process may be continuously performed on the next frame on a per-BU basis.

In the above-described bit rate control method, after encoding on one BU in the frame is done, bit rate control on a next BU may be performed. Accordingly, in the case that encoding is performed on plural BUs constituting one frame, the above-described bit rate control method may not be proper. Accordingly, in the case that parallel encoding is performed with one frame split into plural BUs, a bit rate control method may be provided to be able to minimize a spatial quality gap by allocating a proper bit rate to each split region (BU) so that a user may view an image without any inconvenience.

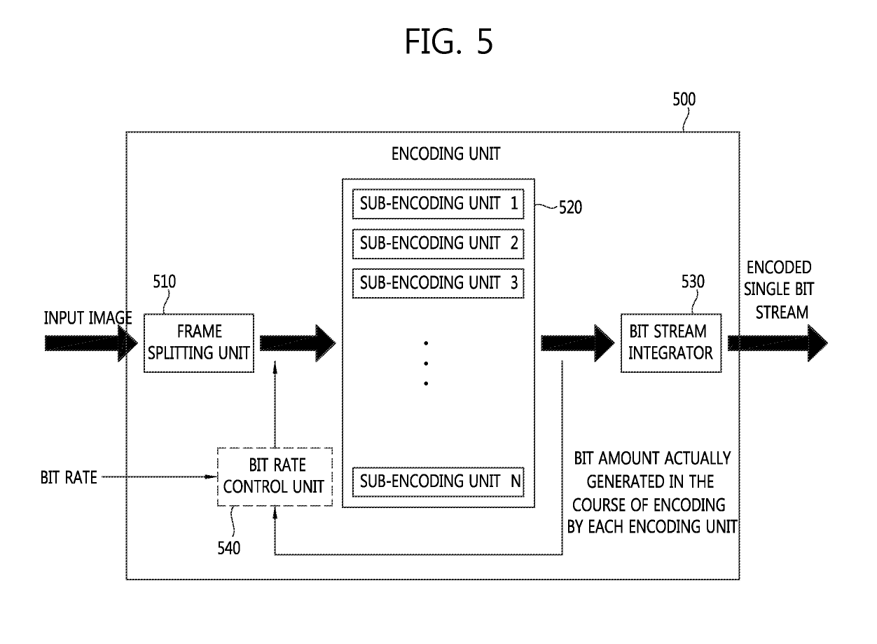

FIG. 5 is a block diagram schematically illustrating a video encoding unit according to an embodiment of the present invention. The video encoding unit 500 illustrated in FIG. 5 may include a frame splitting unit 510, plural sub encoding units 520, a bit stream integrator 530, and a bit rate control unit 540.

As described above, the encoding unit may split one frame into plural regions (BU) and may simultaneously perform encoding on the split plural regions. That is, parallel encoding may be conducted with one frame split into plural BUs. At this time, the encoding unit may perform bit rate control on each split region BU.

Referring to FIG. 5, the frame splitting unit 510 may receive an input image and then may split each frame included in the input image into plural regions (BU). The BUs may be assigned to the sub encoding units 520, respectively, and the sub encoding units 520 may output a bit stream by performing encoding on the assigned BUs. At this time, the BUs may be encoded by the different sub encoding units 520, respectively, and the video encoding unit 500 may simultaneously perform encoding on the BUs of one frame. The bit stream integrator 530 may integrate the bit stream output from the plural sub encoding units 520 and may output an encoded single bit stream.

The bit rate control unit 540 may perform bit rate control on each of the BUs generated by splitting the frame. Since the parallel encoding unit performs encoding on the plural BUs at the same time, a bit rate should be assigned to each BU for bit rate control. Accordingly, the bit rate control unit 540 may receive information on the bit amount actually generated in the course of each sub-encoding unit and the bit rate assigned to the input image (and/or each frame) and may perform bit rate control on each BU.

In the case that encoding is performed on the plural BUs at the same time, if the same bit rate is assigned to each of the plural regions, characteristics of the input image and/or frame may not be sufficiently reflected. Accordingly, in the case that the plural regions are subjected to encoding at the same time, the encoding unit needs to control a bit rate on each of the plural regions.

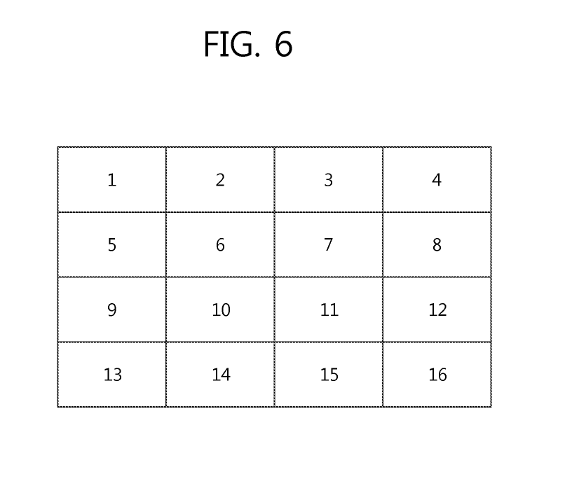

FIG. 6 is a conceptual view schematically illustrating a frame that is split into sub frames according to an embodiment of the present invention. Here, the sub frame may correspond to the above-described BU.

The encoding unit may split one frame into plural sub frames. As an example, the number of sub frames constituting one frame may be 16. At this time, the encoding unit may simultaneously perform encoding on the 16 sub frames.

In the embodiment illustrated in FIG. 6, assume that an image on upper regions 1, 2, 3, 4, 5, 6, 7, and 8 has a simple shape, and an image on lower regions 9, 10, 11, 12, 13, 14, 15, and 16 has a complicated shape. At this time, if encoding is conducted with the same bit rate assigned to all the sub frames, an image quality gap may occur between the upper and lower regions. To address this, the encoding unit needs to assign a bit rate to each sub frame to be appropriate for characteristics of the images.

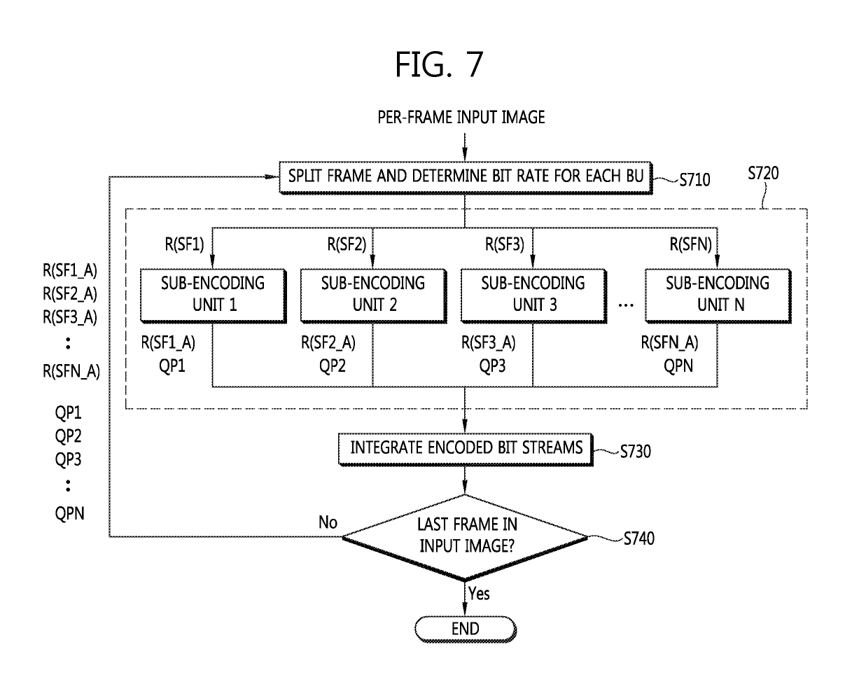

FIG. 7 is a flowchart schematically illustrating a bit rate control method according to an embodiment of the present invention.

As described above, an input image may be input to the encoding unit on a per-frame basis. At this time, the encoding unit may perform encoding with a bit rate assigned to the input image on a per-frame basis.

Referring to FIG. 7, the encoding unit may split a current frame into N (N is a natural number) BUs and may determine a BU target bit amount (R(SFn)) for each BU (S710). Here, BU may refer to a unit in which bit rate control is performed. Since the BU refers to each region of the split frame, the BU may also be represented as SF. R(SFn) may refer to a target bit amount assigned to an nth BU (n is a natural number which is 1 or more and N or less). The target bit rate for each BU of the current frame may be determined by using an average QP value for each BU of a previous frame and the bit amount actually generated for each BU in the course of encoding of the previous frame and may be assigned to each BU to be appropriate for characteristics of the image.

Each BU assigned with the BU target bit amount may be encoded in parallel by each sub-encoding unit (S720). For example, a first BU may be encoded by a first sub-encoding unit, a second BU by a second sub-encoding unit, and an nth BU by an nth sub-encoding unit.

In the course of encoding, the encoding unit may determine the actually generated bit amount and the average QP (Quantization Parameter) for each BU. In FIG. 7, R(SFn_A) may refer to a bit amount actually generated in the course of encoding of the nth BU, and QPn may refer to an average QP value for the nth BU.

Referring back to FIG. 7, the encoding unit may integrate the encoded bit streams output in the N sub-encoding units to output a single bit stream (S730).

If encoding on the current frame is complete, the encoding unit may determine whether the current frame is the last frame in the input image (S740). In the case that the current frame is the last frame in the input image, encoding on the input image may be terminated. Unless the current frame is the last frame in the input image, information on the average QP and the actually generated bit amount for each BU of the current frame may be used to determine a target bit amount for each BU of a next frame. In this case, encoding may be continuously performed on the next frame on a per-BU basis.

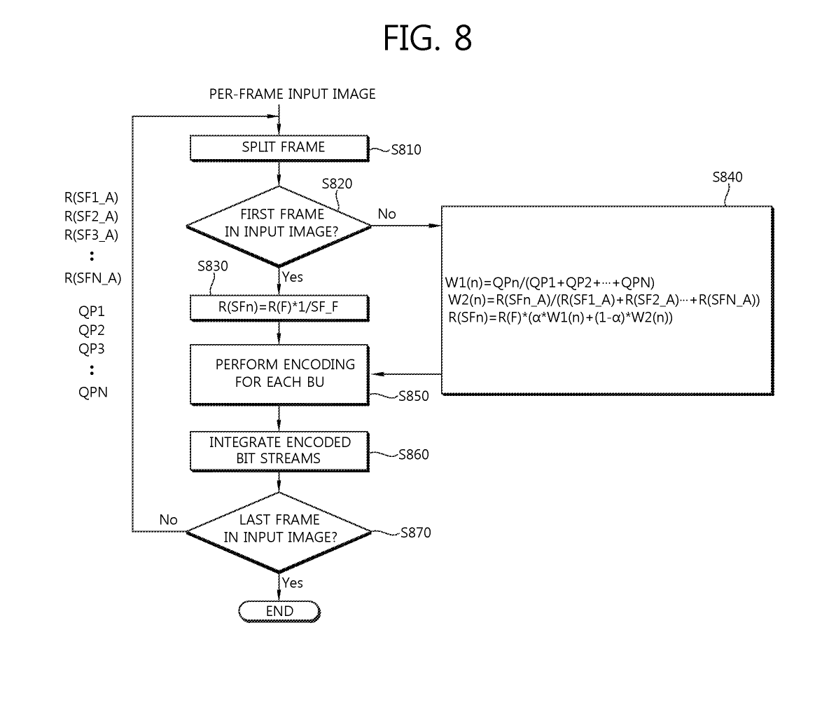

FIG. 8 is a conceptual view schematically illustrating a bit rate control method according to another embodiment of the present invention.

As described above, an input image may be input to the encoding unit on a per-frame basis. At this time, the encoding unit may perform encoding with a bit rate assigned to the input image on a per-frame basis.

Referring to FIG. 8, the encoding unit may split a current frame into N (N is a natural number) BUs (S810). At this time, the N BUs may have the same size. That is, encoding may be conducted with one frame split into N BUs having the same size. Here, BU may refer to a unit in which bit rate control is conducted. The BU refers to each region of the split frame, and thus, the BU may be also represented as SF.

If the current frame is split, the encoding unit may determine whether the current frame is the first frame in the input image (S820).

In the case that the current frame is the first frame in the input image, the encoding unit may determine a BU target bit amount (R(SFn)) assigned to each BU by dividing a frame target bit amount (R(F)) assigned to the current frame by the number (SF_F) of the BUs in the current frame (S830). That is, in the first frame, encoding may be performed with the bit amount obtained by dividing the given frame target bit amount by N evenly assigned to each BU. Here, R(SFn) may refer to a target bit amount assigned to an nth BU (n is a natural number that is 1 or more and N or less).

Unless the current frame is the first frame in the input image, the encoding unit may perform bit rate control on the current frame according to a result of encoding of a previous frame (S840). That is, for the second and the subsequent frames, bit rate control may be conducted using a result of encoding of the previous frame.

In general, in the course of bit rate control, if a target bit amount is assigned, the encoding unit may determine a QP value corresponding to the assigned target bit amount and may perform encoding based on the determined QP value. For example, if the target bit amount is assigned to each BU, the encoding unit may determine a QP value for each BU based on the assigned target bit amount. At this time, as the QP value increases, the bit amount may decrease. Accordingly, the encoding unit may achieve an encoding result similar to the target bit amount by applying a large QP value to a complicated shape of an screen image and by applying a small QP value to a simple shape of a screen image. Meanwhile, in the case that the QP value sharply changes in a screen image or between screen images, image quality may drastically change. To prevent such drastic change in image quality, the encoding unit may generally restrict a range in which the QP value may vary. In such case, there may be a limitation to obtaining a target bit amount in the given QP value range.

In consideration of what has been described above, a screen image having a large QP value and a large encoded bit amount may be highly likely to have a complicated shape. Further, a screen image having a small QP value and a small encoded bit amount may be highly likely to have a simple shape. Accordingly, there may be provided a bit rate control method that controls the bit rate in consideration of both the QP value and the generated bit amount. Specifically, the target bit amount for each BU in the current frame may be determined using the bit amount actually generated for each BU in the course of encoding of a previous frame and an average QP value for each BU in the previous frame.

As an example, after deriving a QP value-based weight and an actually generated bit amount-based weight, the encoding unit may determine a target bit amount (R(SFn)) assigned to each BU in the current frame using the derived weights. The QP value-based weight for the nth BU may be derived using the average QP value for each BU in the previous frame. This may be represented in the following equation 1:

W1(n)=QPn/(QP1+QP2+ . . . +QPN) [Equation 1]

Here, W1(n) may refer to the QP value-based weight for the nth BU. QPn may refer to the average QP value for the nth BU in the previous frame.

The actually generated bit amount-based weight for the nth BU may be derived using the bit amount actually generated for each BU in the course of encoding of the previous frame. This may be represented in the following equation 2:

W2(n)=R(SFn_{—}A)/(R(SF1_{—}A)+R(SF2_{—}A)+ . . . R(SFN_{—}A)) [Equation 2]

Here, W2(n) may refer to the actually generated bit amount-based weight for the nth BU. R(SFn_A) may refer to the bit amount actually generated in the course of encoding of the nth BU.

At this time, the target bit amount (R(SFn)) assigned to the nth BU of the current frame may be calculated using the derived W1(n) and W2(n). At this time, W1(n) and W2(n) may be multiplied by an appropriate weight. This may be represented in the following equation 3:

R(SFn)=R(F)*(a*W1(n)+(1−a)*W2(n)) [Equation 3]

Here, a may refer to a weight applied to W1(n), and (1-a) may refer to a weight applied to W2(n). a may be a value between 0 and 1, and the encoding unit may adjust a ratio to which W1(n) and W2(n) apply by a.

Each BU assigned with the BU target bit amount may be encoded in parallel by each sub-encoding unit (S850). For example, the first BU may be encoded by a first sub-encoding unit, the second BU by a second sub-encoding unit, and the nth BU by an nth sub-encoding unit. In the course of encoding, the encoding unit may determine an actually generated bit amount R(SFn_A) and an average QP value (QPn) for each BU.

Referring back to FIG. 8, the encoding unit may integrate encoded bit streams output from the N sub-encoding units and may output a single bit stream (S860).

The output single bit stream may be transmitted to the decoding unit. At this time, the decoding unit may split the transmitted single bit stream into N bit streams or may de-multiplex the single bit stream. At this time, each of the N bit streams may be a bit stream corresponding to one BU. The decoding unit may generate an image corresponding to the N BUs by decoding the N bit streams, respectively, using sub-encoding units.

If encoding on the current frame is complete, the encoding unit may determine whether the current frame is the last frame in the input image (S870). In the case that the current frame is the last frame in the input image, encoding on the input image may be terminated. Unless the current frame is the last frame in the input image, information on the average QP and the bit amount actually generated for each BU in the current frame may be used to determine a target bit amount for each BU in a next frame. In such case, encoding on the next frame may be continuously performed on a per-BU basis.

By the above-described bit rate control method, the encoding unit may minimize an image quality gap that occurs between split regions (BUs or SFs) in the frame by assigning a relatively large bit amount to a complicated shape of a screen image and by assigning a relatively small bit amount to a simple shape of a screen image in consideration of probabilistic characteristics of an image.

In the meantime, the encoding unit may also use a target bit rate of a frame to be encoded in an intra mode in order to assign a bit amount to each split region (BU) of one frame. For example, the encoding unit may reduce the frame to a low-resolution and may encode the result in an intra mode. At this time, the encoding unit may calculate a bit rate of each of the plural BUs based on a target bit rate calculated for the encoded low-resolution frame. However, the above process includes a process of performing encoding with a frame encoded in an intra mode reduced to a low resolution, and thus, an additional process may be required. Further, the above-described process has the shortcoming that the bit rate for each BU is renewed only on the frame encoded in the intra mode.

According to the present invention, bit rate control may be continuously performed irrespective of an encoding mode of a frame and/or a block. The bit rate control process according to the present invention is performed based on a generated bit amount and QP obtained as a result of encoding, and thus, is advantageous of low complexity.

Although the above embodiments have been described based on a series of steps or blocks or flowcharts, the present invention is not limited to the order of the steps, and rather some steps may occur concurrently with or in a different order from other steps. Further, it will be understood by those skilled in the art that some steps in the flowchart may be non-exclusively included in other steps, or one or more steps in the flowchart may be omitted without affecting the scope of the invention.

The above-described embodiments include various aspects of examples. Although it is not possible to describe all possible combinations to represent various aspects, it will be understood by those skilled in the art that other combinations may be available. Accordingly, the present invention is intended to include all other modifications, alterations, and variations that belong to the appended claims.

1. A video encoding method comprising the steps of:
splitting a current frame into a plurality of first sub frames;
deriving a sub frame target bit amount for each of the plurality of first sub frames;
deriving a plurality of sub frame bit streams each of which corresponds to a single sub frame by performing encoding on the plurality of first sub frames based on the derived sub frame target bit amount; and
integrating the plurality of sub frame bit streams and outputting a single bit stream.

2. The video encoding method of claim 1, wherein the step of deriving the plurality of sub frame bit streams includes performing encoding on each of the plurality of first sub frames using a plurality of sub-encoding units each of which corresponds to a single sub frame.

3. The video encoding method of claim 1, wherein in a case where the current frame is a first frame in an input video, the step of deriving the sub frame target bit amount includes deriving the sub frame target bit amount by dividing a frame target bit amount assigned to the current frame by the number of the plurality of first sub frames.

4. The video encoding method of claim 1, wherein in a case where the current frame is not a first frame in an input video, the step of deriving the sub frame target bit amount includes deriving the sub frame target bit amount based on a bit amount actually generated in the course of encoding of each of a plurality of second sub frames constituting a previous frame and an average QP (Quantization Parameter) value for each of the plurality of second sub frames.

5. The video encoding method of claim 4, wherein the step of deriving the sub frame target bit amount comprises the steps of:
calculating a first weight based on the average QP value;
calculating a second weight based on the actually generated bit amount; and
deriving the sub frame target bit amount by applying the first weight and the second weight to a frame target bit amount assigned to the current frame.

6. A video encoding apparatus comprising:
a frame splitting unit that splits a current frame into a plurality of first sub frames;
a bit rate control unit that derives a sub frame target bit amount for each of the plurality of first sub frames;
a sub frame encoding unit that derives a plurality of sub frame bit streams each of which corresponds to a single sub frame by performing encoding on the plurality of first sub frames based on the derived sub frame target bit amount; and
a bit stream integrator that integrates the plurality of sub frame bit streams into a single bit stream.

7. The video encoding unit of claim 6 wherein the sub frame encoding unit includes a plurality of sub-encoding units each of which corresponds to a single sub frame, wherein each of the plurality of sub-encoding units performs encoding on a sub frame corresponding to the each of the plurality of sub-encoding units.

8. The video encoding apparatus of claim 6, wherein in a case where the current frame is a first frame in an input video, the bit rate control unit derives the sub frame target bit amount by dividing a frame target bit amount assigned to the current frame by the number of the plurality of first sub frames.

9. The video encoding apparatus of claim 6, wherein in a case where the current frame is not a first frame in an input video, the bit rate control unit derives the sub frame target bit amount based on a bit amount actually generated in the course of encoding of each of a plurality of second sub frames constituting a previous frame and an average QP (Quantization Parameter) value for each of the plurality of second sub frames.

10. The video encoding apparatus of claim 9, wherein the bit rate control unit calculates a first weight based on the average QP value, calculates a second weight based on the actually generated bit amount, and derives the sub frame target bit amount by applying the first weight and the second weight to a frame target bit amount assigned to the current frame.

11. A video bit rate control method comprising the steps of:
splitting a current frame into a plurality of first sub frames;
deriving a sub frame target bit amount for each of the plurality of first sub frames; and
deriving a QP value for each of the plurality of first sub frames based on the derived sub frame target bit amount.

12. The video bit rate control method of claim 11, wherein in a case where the current frame is a first frame in an input video, the step of deriving the sub frame target bit amount includes deriving the sub frame target bit amount by dividing a frame target bit amount assigned to the current frame by the number of the plurality of first sub frames.

13. The video bit rate control method of claim 11, wherein in a case where the current frame is not a first frame in an input video, the step of deriving the sub frame target bit amount includes deriving the sub frame target bit amount based on a bit amount actually generated in the course of encoding of each of a plurality of second sub frames constituting a previous frame and an average QP (Quantization Parameter) value for each of the plurality of second sub frames.

14. The video bit rate control method of claim 13, wherein the step of deriving the sub frame target bit amount comprises the steps of:
calculating a first weight based on the average QP value;
calculating a second weight based on the actually generated bit amount; and
deriving the sub frame target bit amount by applying the first weight and the second weight to a frame target bit amount assigned to the current frame.
